(19) United States
(12) Patent Application Publication
(10) Pub. No.: US 2025/0165893 A1
(43) Pub. Date: May 22, 2025

(54) METHOD AND APPARATUS FOR WORKFLOW MANAGEMENT USING A GENERATIVE AI SYSTEM

(71) Applicant: PRICEWATERHOUSECOOPERS LLP, Toronto (CA)

(72) Inventors: Andrew SILCOCK, Toronto (CA); Dave NASTROM, Toronto (CA); Urvi MAHESHWARI, Toronto (CA); Abhinav RAVI, Toronto (CA); Kwesi APPONSAH, Toronto (CA); Sean ZHANG, Toronto (CA)

(21) Appl. No.: 18/947,092

(22) Filed: Nov. 14, 2024

(30) Foreign Application Priority Data
Nov. 17, 2023 (CA) 3220454

(51) Int. Cl. G06Q 10/0633; G06F 3/0484

(52) U.S. Cl. CPC G06Q 10/0633; G06F 3/0484

(57) ABSTRACT

The invention relates to a non-transitory computer-readable storage medium storing instructions, that when executed by one or more computers configures the one or more computers to perform the steps of: (a) receive at an input of the one or more computers, unstructured data; (b) output at an interface of the one or more computers, a request to a Generative Al system to associate the unstructured data to a workflow selected among a set of workflows, wherein each workflow in the set of workflows is characterized by a series of stages; (c) receive from the interface as a result of processing by the Generative Al system an identification of the selected workflow.

### FIELD OF THE INVENTION

The invention relates to computer implemented methodologies and systems for workflow management utilizing a Generative AI framework, notably one that employs a language model like a Large Language Model (LLM). This invention provides advantages in the context of client service delivery, allowing enhanced operational efficiency by minimizing or obviating manual data handling or input, and streamlining service provision to clientele. Furthermore, the disclosed invention is adaptable to a variety of workflow environments and is particularly suited for scenarios using language-based tasks.

### BACKGROUND OF THE INVENTION

In the realm of professional services, encompassing sectors like banking and legal practices, the predominant mode of service delivery hinges on human-centric interactions. This holds particularly true for niche services that necessitate tailoring to specific client needs.

For instance, while rudimentary banking functions might be seamlessly performed through a financial institution's digital portal, leveraging automated processes, the scenario shifts when delving into more specialized service offerings. To illustrate, consider the process of brokering a multifaceted commercial loan. Such a transaction cannot be universally automated, given that the specifics of the loan—encompassing its terms, conditions, and nuances—are likely distinct from other loan agreements that the financial institution has previously sanctioned for other clients.

In light of such complexities, each bespoke service inquiry is channeled to a designated service representative within the institution. This representative, upon understanding the client's needs, triggers a structured workflow. This structured workflow might encompass stages such as document generation, internal task allocation to specialized service personnel, due diligence on the client's credentials, among other steps.

The inherent intricacies of workflows can induce procedural lags and potentially detract from the overall client experience. These workflows are often predicated upon standardized operational protocols, which are subsequently fine-tuned to align with the unique requirements of individual clients.

To elaborate, during specific workflow stages, the necessity for a particular document may arise. Typically, this process commences with a foundational document template, which is then adapted by a team member to reflect the distinct conditions of the loan agreement. While a seasoned service representative might be able to customize this foundational template quickly, ensuring it closely mirrors the loan specifics and thereby presenting the client with a near-finished document necessitating minimal amendments, a less experienced individual might struggle. Their efforts could produce a document that demands extensive alterations, either by the client or their legal counsel.

For example, the foundational template might be crafted to encapsulate terms and conditions spanning a broad spectrum of scenarios. Consequently, many of these predefined terms might not apply to the client's situation. This misalignment can lead the client to grapple with a document that is either lacking in certain aspects, replete with irrelevant clauses, or prompts the client to furnish extraneous data. Such discrepancies foster client dissatisfaction and engender procedural delays.

Given these challenges, there's a clear need within the industry to provide computer-based methodologies to streamline workflows in the service domain through automation, based on simple, high-level directives, such as directives articulated using natural language processing.

### SUMMARY OF THE INVENTION

As embodied and broadly described herein, the invention provides a non-transitory computer-readable storage medium storing instructions, that when executed by one or more computers configures the one or more computers to perform the steps of:
a. receive at an input of the one or more computers, unstructured data;
b. output at an interface of the one or more computers, a request to a Generative AI system to associate the unstructured data to a workflow selected among a set of workflows, wherein each workflow in the set of workflows is characterized by a series of steps;
c. receive from the interface as a result of processing by the Generative AI system an identification of the selected workflow.

A Generative AI system, also known as a Generative model, is a type of artificial intelligence that is designed to generate new data samples that resemble a given dataset. It is a class of AI models capable of learning the underlying patterns and structures of the training data and then using that knowledge to produce new, synthetic data that resembles the original data distribution. In a specific, yet non-limitative, implementation illustration, a client might engage with a service representative from a financial institution, expressing interest in procuring a commercial loan. The client could delineate general parameters like the desired loan amount, the intended use of the funds, the acceptable interest rate range, and the preferred amortization timeline.

Subsequent to the client interaction, the service representative compiles debriefing notes summarizing the discussion with the client. These notes constitute the service request, delineating the client's requirements, notably stating the fundamental parameters of the loan. Inputting these debrief notes is accomplished through a Graphical User Interface (GUI), serving as the data entry point for the one or more computer systems. Activation of a GUI control, such as a virtual button, triggers the transmission of the service request to a Generative AI system, which, in turn, aligns the request with a workflow. This workflow represents an internal procedural sequence within the banking institution designed to provide a specific product or service to the client. Banking institutions typically maintain multiple such workflows, encompassing diverse service categories, including commercial loans, private loans, and money transfers, among many others, each structured into discrete stages or phases.

In the context of a commercial loan, the initial stage often entails the creation of a Letter of Intent (LOI). Functionally, an LOI is a formal, documented instrument delineating the preliminary consensus between the bank and the client concerning a particular commercial loan. It serves as an instrument to express one party's intent to engage in a business relationship with another party. While an LOI is typically not legally binding, it functions as a foundation for formalizing future negotiations and agreements pertaining to the commercial loan. Consequently, the output of the first stage consists of an LOI document dispatched to the client for execution.

Although the LOI encapsulates the broad terms of the loan request as indicated in the service request, it also introduces more granular terms and conditions necessitating discussion and concurrence with the client during the LOI phase before advancing to subsequent phases of the workflow.

Presuming the successful conclusion of the initial LOI workflow phase, the subsequent phase could encompass an internal due diligence process, entailing the accumulation of information pertinent to the client and their project. This phase may also activate a communication with the client to solicit specific project-related and financial information.

The third stage, leveraging the output from the second stage, comprises an internal approval procedure, leading to a binary decision regarding the loan, either approval or rejection. At this juncture, client communication may be initiated to convey the decision outcome.

Finally, the fourth stage involves the preparation of the final commercial loan deal documentation, which is sent to the client for review, signature and ultimately the disbursement of funds.

After the initial request for service is sent to the Generative AI system, the system processes the request and selects a workflow among a set of possible workflows. The Generative AI system returns an identification of the selected workflow.

In the example described above the request for service is entered as text, namely the service representative types-up debrief notes in a GUI after the service representative has spoken to the client. Another approach involves the real-time generation of the service request during a client's telephone interaction. In this scenario, the spoken conversation is converted into text format through a speech-to-text conversion process. The resulting text transcription subsequently serves as the foundation for the service request. In this example of implementation, the output of the Generative AI system in response to the audio service request can be conveyed in real time to the service representative in order to assist the service representative with more focused questions or queries related to the service request, while the telephone interaction is ongoing.

In a specific example of implementation, the method and system according to the invention is functionally integrated in a Customer Relationship Management (CRM) software application. CRM software refers to a category of software solutions that help organizations manage interactions with current and potential customers. CRM software centralizes, simplifies, and automates customer relationship management processes, making it easier for businesses to organize, track, and foster their customer relationships.

A typical CRM solution is designed to perform one or more of the following functions, among others:
Contact Management: Stores detailed information about each customer, including contact details, communication history, and even social media profiles. This ensures that businesses can view and manage details about their customers, making interactions more personalized and informed.
Sales Force Automation: Tracks and manages sales processes, from lead generation to closing a deal. This includes setting reminders for follow-ups, tracking interactions, and predicting future sales.
Marketing Automation: Helps businesses automate repetitive marketing tasks, such as sending out email campaigns to different segments of customers or tracking the effectiveness of various marketing strategies.
Customer Service & Support: Provides tools to manage customer service requests, track issues, and automate certain support tasks. This ensures that customers receive timely support, and their feedback is properly channeled within the organization.
Analytics & Reporting: Offers insights and reports on various metrics related to sales, customer service, and marketing efforts. This helps businesses make informed decisions and understand their customer base better.
Integration: Most CRM systems integrate with other business tools and platforms, such as email services, social media platforms, and enterprise resource planning (ERP) systems. This ensures a seamless flow of data across various tools.
Task and Calendar Management: Allows for the scheduling of appointments, calls, and meetings, and the setting of reminders, ensuring that important activities related to customer interactions aren't missed.
Document Management: Some CRM systems also provide document storage, where sales or service documents can be stored and retrieved easily.

As embodied and broadly described herein, the invention further provides a method executed by one or more computers comprising the steps of: (a) receive at an input of the one or more computers, unstructured data; (b) output at an interface of the one or more computers, a request to a Generative AI system to associate the unstructured data to a workflow selected among a set of workflows, wherein each workflow in the set of workflows is characterized by a series of steps; and (3) receive from the interface as a result of processing by the Generative AI system an identification of the selected workflow.

As embodied and broadly described herein, the invention further provides a system comprising one or more computers and one or more storage devices storing instructions that when executed by the one or more computers causes the one or more computers to perform the steps of: (a) receive at an input of the one or more computers, unstructured data; (b) output at an interface of the one or more computers, a request to a Generative AI system to associate the unstructured data to a workflow selected among a set of workflows, wherein each workflow in the set of workflows is characterized by a series of steps; (c) receive from the interface as a result of processing by the Generative AI system an identification of the selected workflow.

As embodied and broadly described herein, the invention further provides a non-transitory computer-readable storage medium storing instructions, that when executed by one or more computers configures the one or more computers to perform an information gap assessment in relation to a workflow, comprising the steps of:
a. receive at an input of the one or more computers, unstructured data;
b. derive from a CRM record maintained by the one or more computers a plurality of keys associated with information items to execute a workflow;
c. output at an interface of the one or more computers, a request to a Generative AI system to associate values contained in the unstructured data with respective ones of the keys;
d. receive from the interface as a result of processing by the Generative AI system a response conveying values associated with at least a subset of the keys;
e. identifying from the response an information gap, including identification of one or more keys that have no values.;
f. display the one or more keys to a user via a GUI.

As embodied and broadly described herein, the invention further provides a method executed by one or more computers comprising the steps of:
a. receive at an input of the one or more computers, unstructured data;
b. derive from a CRM record maintained by the one or more computers a plurality of keys associated with information items to execute a workflow;
c. output at an interface of the one or more computers, a request to a Generative AI system to associate values contained in the unstructured data with respective ones of the keys;
d. receive from the interface as a result of processing by the Generative AI system a response conveying values associated with at least a subset of the keys;
e. identifying from the response an information gap, including identification of one or more keys that have no values.;
f. display the one or more keys to a user via a GUI.

As embodied and broadly described herein the invention further provides a system comprising one or more computers and one or more storage devices storing instructions that when executed by the one or more computers causes the one or more computers to perform the steps of:
a. receive at an input of the one or more computers, unstructured data;
b. derive from a CRM record maintained by the one or more computers a plurality of keys associated with information items to execute a workflow;
c. output at an interface of the one or more computers, a request to a Generative AI system to associate values contained in the unstructured data with respective ones of the keys;
d. receive from the interface as a result of processing by the Generative AI system a response conveying values associated with at least a subset of the keys;
e. identifying from the response an information gap, including identification of one or more keys that have no values.;
f. display the one or more keys to a user via a GUI.

### BRIEF DESCRIPTION OF THE DRAWINGS

FIG. 1 is a block diagram which presents an overview of the computer and network architecture that employs a Generative AI system to associate client requests with workflows.

FIG. 2 is a more detailed block diagram of a CRM software application, highlighting the main software functionalities responsible for executing the process of associating client requests with workflows.

FIG. 3 is a flowchart of a process illustrating steps of a process performed by the CRM software application illustrated in FIG. 2.

FIG. 4 is a high-level depiction of a Graphical User Interface (GUI) presented to a user to obtain user input for validating the keys in a data schema used for the conversion of unstructured data in a structured format.

FIG. 4A illustrates a variant of the GUI shown in FIG. 4;

FIG. 5 illustrates a code snippet of a general schema definition prompt, according to a JSON format.

FIG. 6 illustrates a code snippet of a basic field definition prompt, according to a JSON format.

FIG. 7 illustrates a code snippet of a nested field definition prompt with instructions, choices, and examples, according to a JSON format.

FIG. 8 illustrates a JSON code snippet in which is embedded the unstructured data. From this data, a Generative AI system is expected to derive values corresponding to the provided keys.

FIG. 9 is a block diagram illustrating the architecture of an API gateway to interface a computer system implementing a CRM software application and a Generative AI service.

FIG. 10 is a general depiction of GUI showing a control allowing a user to validate the key/value combinations output by a Generative AI system before storage in a CRM record.

FIG. 11 is a diagram which summarizes the process of conversion of unstructured text into a structured format from the perspective of the user of a CRM software application.

FIG. 12 is a diagram which illustrates another example of application of the invention for converting an employment confirmation letter into structured data which is stored in a CRM record.

FIGS. 13 and 14 are diagrams which illustrates yet another example of application of the invention for the extraction of coverage details from an insurance policy contract and then storage of the coverage details in a CRM application.

FIG. 15 is a high-level depiction of a GUI showing a control for the validation of values generated in the context of a commercial loan workflow.

FIG. 16 is a flowchart of a process allowing a service representative to perform workflow selection.

FIG. 17 is a high-level representation of a GUI allowing a service representative to make workflow/context selection.

FIG. 18 is a high-level flowchart illustrating the workflow selection and individual stages of the workflows.

FIG. 19 is a GUI associated with a segment of a CRM record, which relates to particular workflow.

FIG. 20 is a process flow illustrating the various steps performed during a commercial lending workflow.

FIG. 21 is a depiction of a GUI which illustrates the results of a gap analysis.

FIG. 22 is a high-level depiction of a GUI of a real-time assistant functionality.

### DESCRIPTION OF AN EXAMPLE OF IMPLEMENTATION

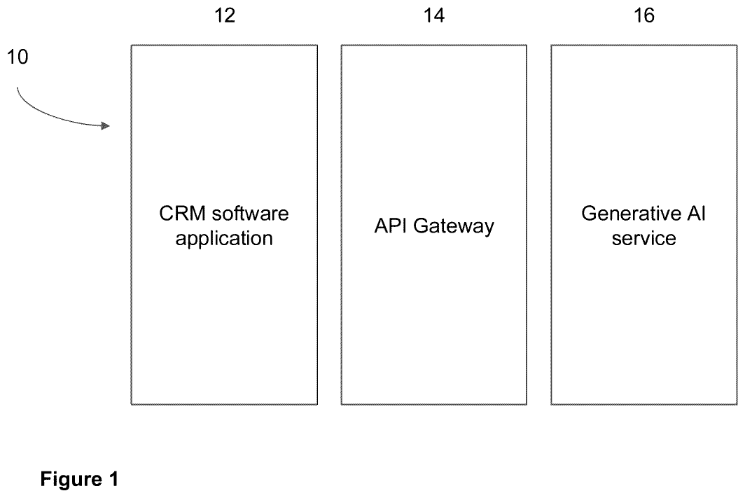

FIG. 1 presents a top-level illustration of the system architecture employing a Generative AI system to facilitate client request processing. More specifically, the system is designed to identify the appropriate business process workflow based on a client request expressed in unstructured form, such as natural language, encompassing both text and audio inputs. Furthermore, the system is optionally configured to perform the conversion of these unstructured, natural language service requests from clients into a structured format. This transformation is aimed at simplifying the process of data entry into the customer relationship management (CRM) system, which serves as a repository for business and client records.

In the specific scenario of a CRM software application, the optional conversion to structured text is desirable because it facilitates the data entry into the CRM system's records. These records can encompass both business records and client records or other kinds of records. When dealing with client records, the records can contain details about individual clients and their business dealings with the organization maintaining the CRM software application.

The system designated globally by 10, comprises three main modules, namely a CRM software application 12, an API gateway service 14 and a Generative AI service 16, which in this example is powered by a Large Language Model (LLM). The Generative AI service 16 implementing the LLM typically employs attention mechanisms to process the input data and output synthetic data that resembles the original data distribution of the model training data. The U.S. Pat. No. 10,452,978 issued to Google LLC., provides an example of the structure and operation of an attention-based sequence transduction neural network.

The CRM software application 12 encompasses the software infrastructure responsible for the implementation of the CRM software application. This infrastructure can either be locally deployed or hosted in the cloud. The CRM software application 12 serves as a comprehensive platform, managing a multitude of records while offering various data-related functionalities. It is to be understood that while reference is made to a software infrastructure, the necessary computer hardware is also required to execute the software and implement the functionalities of the CRM software application 12. The hardware associated with the CRM software application 12 is not being discussed here in detail because it is an aspect known in the art.

These functionalities include client management, sales force automation, marketing automation, customer service and support, analytics and reporting, integration capabilities, task and calendar management, as well as document management, among other features.

The records stored within the CRM software application 12 are designed to hold client or business information. To ensure efficient processing, these records employ structured data, which follows a predefined format understood by the CRM software application 12. One simple example of a structured format is the organization of data in rows and columns, where each column represents a key, and each row represents a specific value corresponding to that key.

For instance, when dealing with client records, keys might include the client's name, address, telephone number, and more. This structured approach to data representation enables the CRM software application 12 to easily interpret and manage the information efficiently.

The API gateway service 14, functions as an intermediary linking the CRM software application 12 to the Generative AI service 16. Its primary role involves managing the flow of data between the CRM software application 12 and the Generative AI service 16.

When the CRM software application 12 makes calls, the API gateway service 14 receives them, and if necessary, performs pre-processing tasks before passing them on to the Generative AI service 16. Subsequently, the API gateway service 14 receives the results produced in response to the calls from the Generative AI service 16 and relays them back to the CRM software application 12.

Within the CRM software application 12, the calls made to the API gateway service 14 can be categorized into two distinct types: service calls and result calls.

Service calls entail the submission of a specific request to the Generative AI service 16. These calls initiate the processing of the Generative AI service 16 to generate relevant information or outcomes.

In contrast, result calls serve the purpose of retrieving the results that have been generated as a consequence of the processing carried out by the Generative AI service 16. These result calls are made subsequent to the initial service call and allow obtaining the actionable insights or data produced by the Generative AI service 16.

By orchestrating this exchange of service and response calls, the API gateway service 14 streamlines the flow of information between the CRM application 12 and the Generative AI service 16.

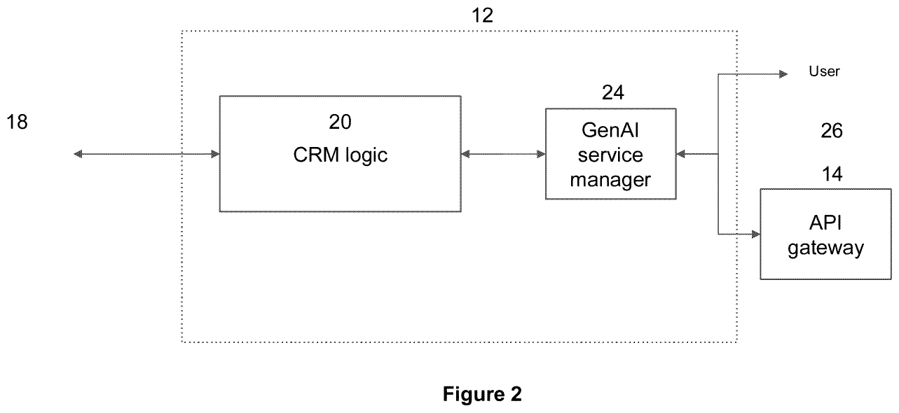

FIG. 2 is a more detailed block diagram of the CRM software application 12 illustrating the main functionalities for performing workflow management including the optional steps of performing the conversion of unstructured text into a structured format.

The CRM software application 12 has a main functional block 20, denoted as CRM logic 20 which generically refers to the traditional functions that the CRM software application 12 provides to users. Those include contact management, sales force automation, analytics, and reporting, etc.

In the context of the CRM software application 12, a data record or simply a record, refers to a collection of related information or data elements that are treated as a unit. Records are used to represent individual instances or entities within a dataset or database. The information stored in a record can be organized around the notion of keys, where each key holds specific pieces of information about the entity being represented. For example, in a customer database, each record would correspond to a specific customer, and the keys might include the customer's name, address, phone number, email, and purchase history. The CRM software application 12 stores the records in a storage device, such as a database, denoted as 18. As it will be discussed later in greater detail, a record can define one or more workflows. A workflow refers to a sequence of operations, organized chronologically or logically, designed to accomplish a specific business process. It outlines the pattern of activities and tasks necessary to achieve an objective. Workflows are often used in businesses and organizations to ensure that processes are standardized, efficient, and consistently followed. An example of a workflow in a banking context is a commercial lending process which includes a series of stages, such as an LOI stage, a due diligence stage, etc. The workflow is embedded within the record to facilitate the user in carrying out the prescribed process. Specifically, this record dictates the order of workflow stages, stipulates the required data for each stage, and prescribes the necessary operations on said data, among other functionalities. Conventionally, a single record encompasses multiple workflows, each representing distinct business processes, to streamline user execution of these processes. These workflows may pertain to services the organization offers to clients, including but not limited to financial or legal services, or they may be tied to internal operational procedures. The database 18 can exist in two configurations: local or remote. In the local setup, the database 18 is hosted on the same servers that execute the CRM logic 20. This arrangement can offer efficient data access and processing, as the database 18 is in close proximity to the CRM software application's computational resources. Alternatively, in the remote setup, the database 18 is situated on separate servers, physically distant from the ones executing the CRM logic. These servers are interconnected via a network to facilitate data communication and management.

Although the diagram at FIG. 2 depicts database 18 as a single entity, it should be recognized that it can be designed in a distributed manner. This means that multiple data storage devices, located at various geographical locations, can be interconnected through networking protocols. In this distributed configuration, the individual storage devices work collaboratively to behave as a unified and cohesive data storage unit.

Similarly, the CRM software application 12 offers two implementation options: local and distributed. In the local implementation, the CRM software application's computer code runs on CPUs/GPUs hosted on servers physically situated near the user. This proximity allows for efficient and fast execution of the CRM software application 12, enhancing user experience and responsiveness. On the other hand, the distributed implementation involves executing different modules of the CRM software application 12 in remote locations, which are interconnected through a network. This distributed architecture enables the CRM software application 12 to leverage resources from multiple locations, facilitating scalability and load balancing for handling larger user bases and heavier workloads.

The CRM software application 12 includes a Generative AI service (GenAI service) manager 24. This manager is software implemented and it is responsible for handling data processing and orchestrating various functions necessary for performing workflow selection and management including the optional steps of converting unstructured data into a structured format. Usually, the operation of the GenAI service manager 24 remains invisible to the user, occurring behind the scenes, with the exception of certain events visible by the user such as Graphical User Interfaces (GUI) as they relate to workflow management and other optional steps.

Generally, the GUI interface through which users can interact with the CRM software application 12 allows users to access, manipulate, and make informed decisions based on the information managed by the CRM software application. Such GUI interface enables the subsequent generic functions:
Data Visualization: The GUI interface allows users to view information residing in the records stored within the database 18. Users can access and examine relevant data presented in a user-friendly graphical format, making it easier to comprehend and analyze.
Processed Data Presentation: The GUI interface also displays information generated as a result of data processing or analysis carried out on the records stored in the database 18. This allows users to visualize insights, reports, or statistical summaries derived from the CRM software application's data.
Data Input and Modification: Users can input new data or modify existing information through the GUI interface. This input can be related to clients, business interactions, or any other details stored in the records of the CRM software application 12. Any newly entered or modified data is then saved in the corresponding records.
Command Execution: Users can direct the CRM application 12 to perform various functions on the records stored in the database 18 using the GUI interface. These commands may involve specific data operations, data retrieval, data updates, or other functionalities offered by the CRM system.

The GenAI service manager 24 interacts with the CRM logic 20 to create a user interface (GUI) on the user's display. This GUI offers functionalities tailored to workflow selection and management and optionally the conversion of unstructured data into a structured format. These functionalities are achieved through an array of visual elements or controls, designed to engage the user. The visual elements associated with the workflow selection and management and the conversion function serve two primary purposes:
Displaying Information: The GUI visual elements present relevant information to the user. This could include data generated by the Generative AI service 16 for user validation, data from records stored in the database or processed results such as reports, charts, or graphs.
Accepting User Input: Users can interact with the visual elements to provide data, such as entering information for processing by the Generative AI service 16, information related to clients or modifying existing records. Additionally, the visual elements can accept commands from the user, directing the CRM software application 12 to perform specific functions or operations on the data.

In an optional scenario under the overarching concept of workflow management, the GenAI service manager 24 creates initially a data schema that defines the desired structure for organizing unstructured data. The GenAI service manager 24 also initiates API calls to the API gateway service 14 through a network interface, signaling a request to transform the unstructured data into a structured form using the capabilities of the Generative AI service 16.

Also, the GenAI service manager 24 requests structured data results from the API gateway service 14. Specifically, the GenAI service manager 24 generates a response request to the API gateway service 14, seeking the structured data results. This response will contain the data in the organized and structured format ready for utilization within the CRM application 12.

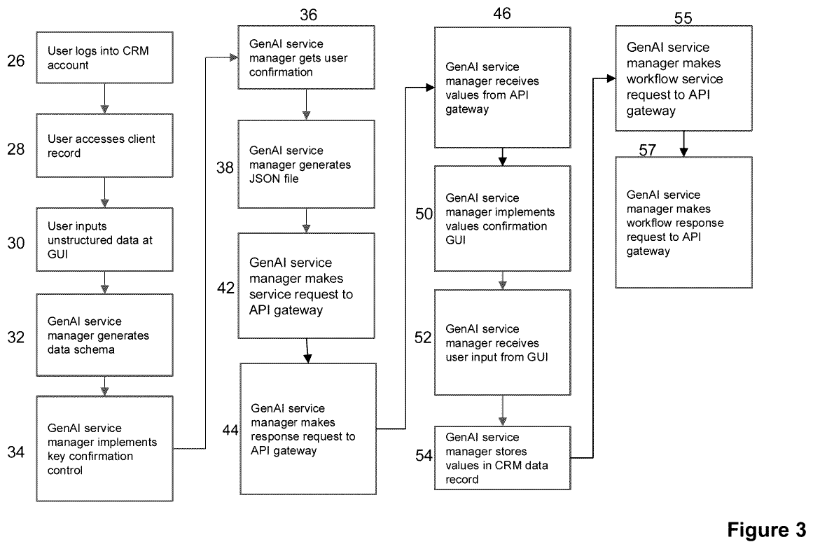

FIG. 3 is a flow-chart that illustrates in greater detail the functionality of the CRM software application 12 and in particular the functionality of the GenAI service manager 24 under that particular scenario.

In FIG. 3's flowchart, steps 26 to 54 depict the optional text structuring process, which is a preparatory step for the generic workflow management operation outlined in steps 55 to 57. This two-phase approach proves beneficial in specific scenarios, especially when the data obtained from the client during the debriefing by the service representative must be documented within a client record before initiating the workflow. A concrete illustration of this is when a service representative engages with a new client and, prior to commencing any work, needs to create and populate a client record with pertinent information.

Note that for the purpose of the following description, “user” and “service representative” will be used interchangeably.

At step 26 a user accesses the CRM software application 12 by submitting log-in credentials, such as a username and password. At step 28, the user accesses a particular data record, such as a client record. In that process, the user identifies the desired client record and the CRM logic 20 will fetch the desired record from the database 18 and display the record on the user display. Assume in this example, that the user is the sales representative, and the user is talking to a client on the phone while taking notes on an advisory notes section implemented at the GUI, as depicted by step 30 in the flowchart. The notes are as follows:
“John Doe is a real estate developer, and he has a commercial project that requires financing. John deals with Bank X, however he is reaching out to other banks to get several lending proposals. His project relates to the development of a retail store complex in the New District area. John owns the land, and he needs financing to build the store complex. He estimates that he would need $ 50 million dollars in financing to complete the project. The amortization period should not exceed 15 years and the maximal interest rate he wants to pay is 3.8%. He also mentioned that he is a Toronto Maple Leaf fan and enjoys playing hockey with friends. His address is 1236 Cedar Avenue, Toronto, Ontario. John can be reached at his cell phone #432-568-1397.”

After writing the advisory or debrief notes following the call with the client, the user triggers the conversion process, by actuating a control on the GUI, such as clicking a virtual button.

At step 32 the GenAI service manager 24 generates a data schema, which includes keys, that represent categories of information that will be used to structure the free-form text entered as advisory notes. In one example, the keys can be static; in other words, they do not change from one set of advisory notes to another. That is to say, different sets of advisory notes are structured according to the same keys. In this example, the keys are stored at a preset memory location and the GenAI service manager 24 reads the keys from that memory location to generate the static data schema. For instance, the static keys can be specific to the user, and they can be stored in the user profile. The static keys may include the following: “name” and “telephone number”. In that example, the data structuring operation would identify in the unstructured text the values associated with the static keys and return those values. In this example, the static keys can be selected to reflect the basic elements of information necessary to open a new client record in the CRM system.

In an alternate approach, the keys are dynamically generated. One way to achieve this is by extracting the keys from a data record of the CRM software application 12, such as the data record currently accessed by the user. The data record can be a blank data record or an existing data record which already contains some information about the client. In either scenario, the GenAI service manager 24 analyzes the content of the opened data record and identifies various categories of information present within it. These categories act as the keys that represent different aspects of the data which is needed for that particular record. In a simple example, when data in the record is organized as rows and columns, the keys could be the column headings. In this example, the GenAI service manager 24 reads the column headings, and they constitute the keys.

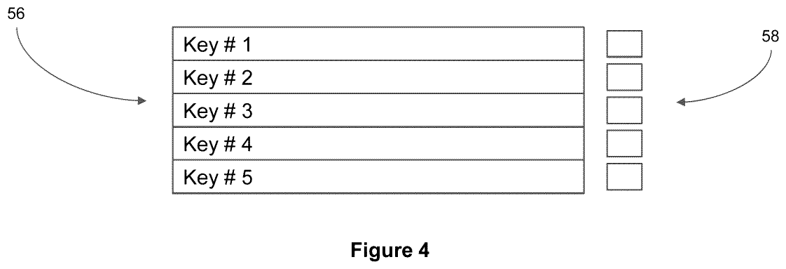

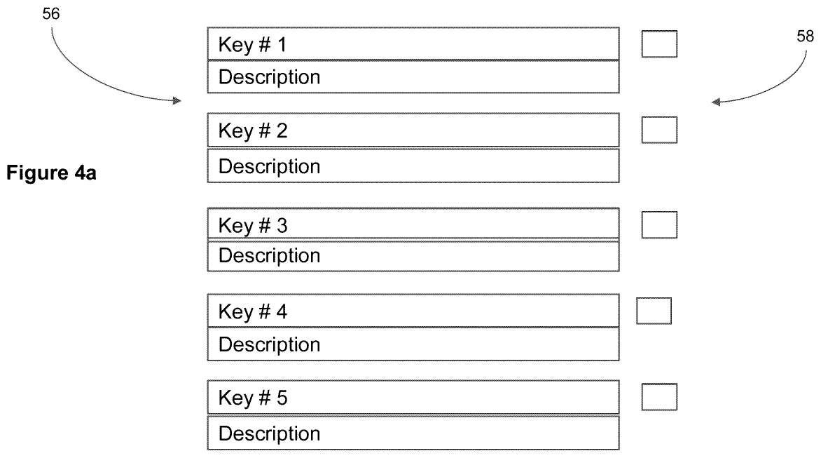

Optionally, at step 34, the GenAI service manager 24 produces a list of the extracted keys and presents it to the user for validation. FIG. 4 shows an illustrative GUI control designed for this purpose. The control depicts a list of the extracted keys at 56. Reference numeral 58 denotes a control with multiple selectable options, like checkboxes, enabling the user to individually choose and thereby individually validate keys based on two exemplary criteria: (1) accurate extraction from the CRM record and (2) relevance to the text structuring operation. Note that even if keys are accurately extracted from the CRM record, some keys might not be needed for the structuring operation, and thus, could be unchecked.

As it will be discussed below, keys function as components of a prompt for guiding the Generative AI service 16 to structure the free-form text. The manner in which these keys are articulated significantly affects the structuring of the text. Although a specific key phrase derived from a CRM record might work well at a basic level, the raw phrasing of the key might not be the most effective from a machine directive standpoint when higher levels of efficiency and accuracy are desired. Advantageously, the GUI control depicted in FIG. 4 is provided with editing features, allowing users to modify the individual keys displayed at 56. In this setting, the fields displaying the keys aren't fixed but are modifiable. Here, a user can modify a key for clarity, to elicit from the Generative AI service 16 a more accurate identification of correlating values in the free-form text. For instance, a key pulled from a CRM record could be an abbreviation or an acronym. When utilized as a component of a prompt, this short form might not best guide the Generative AI service 16 in identifying in the free-form text values related to the said abbreviation or acronym. In such cases, altering the key's phrasing can potentially enhance outcomes.

In a possible variant, the GUI control in FIG. 4 is provided with additional fields where the user can enter additional information to augment or otherwise condition the machine instructions in the key fields. The variant of this GUI control is shown at FIG. 4A. As is shown in FIG. 4A, each key field is associated with a description field in which the user can enter additional information, which works as additional prompt details to guide the Generative AI service 16 toward a better structuring of the free-form text. The data that can be entered into the designated description fields encompasses the following functional categories, among others:
Examples: Incorporating examples into a prompt for a language model, notably a comprehensive model like an LLM (Large Language Model), is a method to steer its responses. Through offering examples, users set a context, guiding the model towards the anticipated response. For instance, a key such as “Life events” might be too vague on its own and could benefit from added detail. Within this field, users can specify which life events they aim to log in the CRM record from the myriad of potential life events that can appear in the free-form text. In a specific example, the user may enter in the field examples of life events, such as “graduation”, “marriage”, etc.
Format: Specify the structure in which the Generative AI service 16 will display the value discerned from the unstructured text. This ensures compatibility with the expected CRM record format, especially for entries like dates.
Output Constraints: Confine the values detected in the unstructured text to certain predefined categories. To illustrate, for the key “bank accounts,” the output could be restricted to specific bank account categories: credit card, checking account, credit margin, and mortgage account. Thus, even if the unstructured text mentions an investment account, if it's not pertinent to the CRM record, excluding it from the description field ensures its omission from the Generative AI service's response.

In yet another alternative scenario, the GUI allows the key fields to remain blank, allowing the user to manually input the keys. In this case, the CRM record does not provide any key information, and it is up to the user to determine the relevant categories of information needed to organize the free-form text. The user then lists these desired categories in the GUI control to define the keys.

Referring back to the flowchart at FIG. 3, in particular to step 36, the GenAI service manager 24 captures the user inputs from the GUI control 58 and from other user-modifiable fields. These inputs encompass the identification of the keys that will guide the conversion process, any modifications to the raw wording of keys, and the information provided in the corresponding description fields.

At step 38, the GenAI service manager 24 builds the data schema, which includes arranging the unstructured data, the keys, and optionally the descriptions in a data structure which adheres to a data interchange format. JSON is an example of a data interchange format, however other formats such as XML and YAML can also be considered, among others. The output from the GenAI service manager 24 is JSON data, which operates as a prompt for the the Generative AI service 16. This prompt guides the Generative AI service 16 to identify values in the unstructured data that match the keys.

As it will be described in greater detail below, the various components of the prompt that the Generative AI service 16 will use to structure the unstructured data, namely the unstructured text and the key/value combinations are embedded in respective JSON objects. Specifically, the unstructured data is placed in a first JSON object, and each key is placed in a respective JSON object.

A prompt for a Language Learning Model (LLM) is a set of machine instructions expressed in natural language, such as a specific query or statement designed to elicit a particular response from the model. In essence, it serves as the input that guides the LLM to generate an output based on its training. The LLM interprets the prompt and responds with information or content that aligns with the intent behind the prompt.

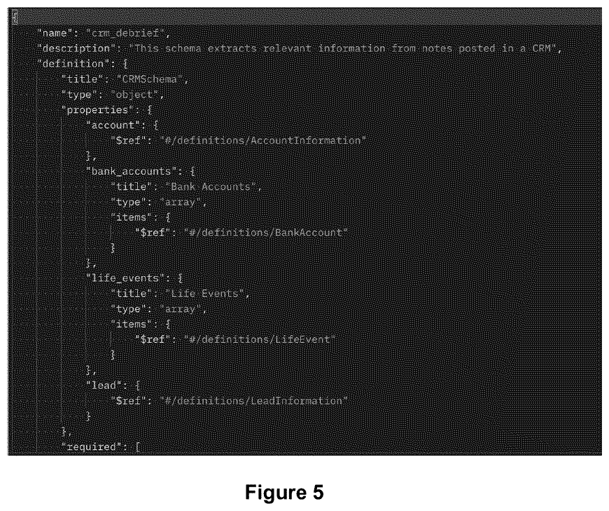

FIG. 5 is a code snippet illustrating a general schema definition prompt that adheres to the JSON format and that operates to instruct a Generative AI system to perform a certain task. The code listing in FIG. 5 identifies several keys and also provides placeholders for the values to be extracted from the unstructured text, which are associated with the respective keys. Examples of keys include “Bank accounts” which is defined as an array type JSON object with a placeholder to receive a list of values from the unstructured text that match the meaning of “Bank accounts”. Another key is “Life events”, also defined as an array type object, where values from the unstructured text that associate with “Life events” will be put.

The key's title field holds the name of the key, either in its raw form as extracted from the CRM record or as modified via the GUI shown at FIGS. 4 and 4A. The data placed in the title field is a component of the overall prompt and operates as machine instructions, guiding the Generative AI system to recognize values in the unstructured data correlating with the data in the title field. When the unstructured data is text, the content within the title field constitutes the machine instructions, leading the Generative AI system to generate outputs that match values in the unstructured text to the key's title. Notably, employing the title field of an object in the JSON data as a means to transmit machine instructions to a Generative AI system represents a new and advantageous optional aspect of the invention.

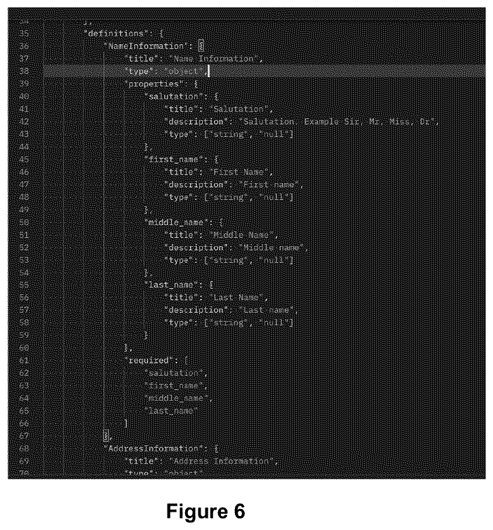

FIG. 6 shows a code snippet in JSON format, wherein the “description” field of a JSON object offers further direction to the Generative AI system for shaping its output. In one instance, this guidance pertains to the structure of the response produced by the AI system.

Typically, the description field within the JSON format serves to offer supplementary details regarding the data in the “title” field. Traditionally, this description field is intended for human understanding and isn't used to convey machine instructions. However, in this invention, the description field is repurposed to convey a second component of the overall prompt, which operates as machine commands, articulated in natural language, to a Generative AI system.

The GenAI service manager 24 receives the description inputs generated by the user via interaction through the GUI at FIG. 4A and places the description inputs in the respective description fields of the JSON data.

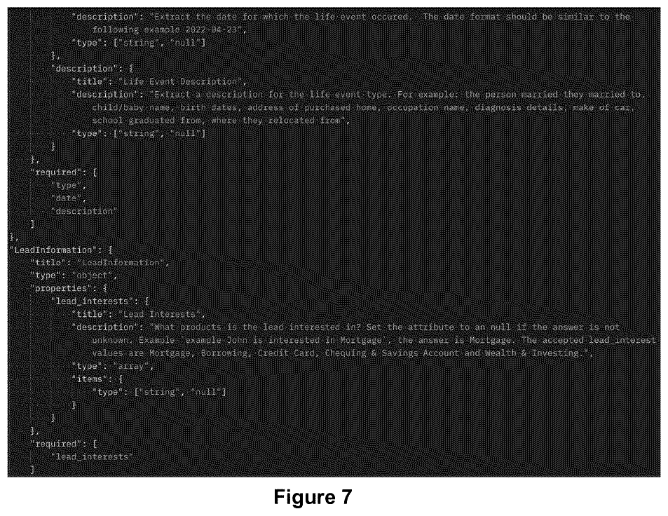

FIG. 7 is an example of a code snippet in the JSON format of a nested field definition prompt, listing instructions, choices, and examples. In the example of the code snippet, the description guides the Generative AI system to answer in the correct JSON format. For instance, the instructions specify the JSON “null” attribute to output, if no valid answer to the “lead interest” key exists in the unstructured text. Second, it constrains acceptable categories of responses to a specific number of categories, for example mortgage, borrowing, credit card, checking & savings account and wealth & investing.

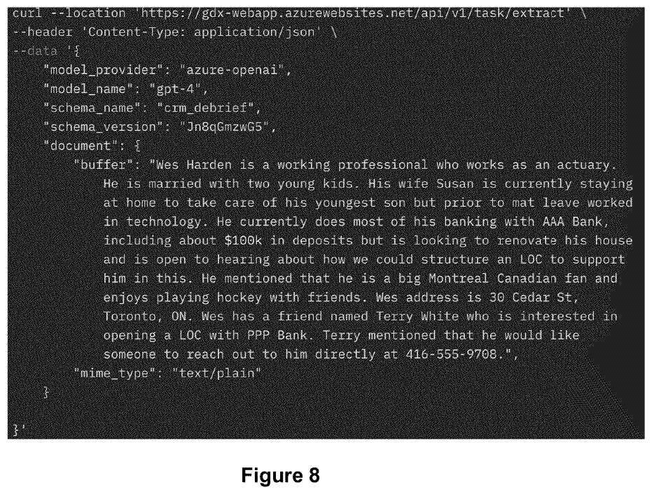

FIG. 8 presents a code excerpt illustrating the incorporation of unstructured data into JSON data. The free-form text is represented using the key “text”, with its corresponding value being the free-form text content. This approach, again, diverges from conventional JSON format practices. In this invention, the value linked to a key in the JSON data operates to supply the embedded background data on which the Generative AI system should operate. In this example, the embedded background data is the unstructured text in which the Generative AI system will look for values relating to the requested keys.

Referring back to the flowchart in FIG. 3, step 40 depicts the step where the GenAI service manager 24 outputs the JSON data. The schema definition contained within the JSON data is used to provide additional instructions and examples for the generative AI service. This data can be utilized to produce the prompt for the Generative AI service 16.

At step 42, the GenAI service manager 24 outputs the JSON data at a network interface and makes a service call to the API gateway service 14. The API gateway service 14 passes this call and the JSON data to the Generative Al service 16, which uses a Generative AI system in the background to service the call.

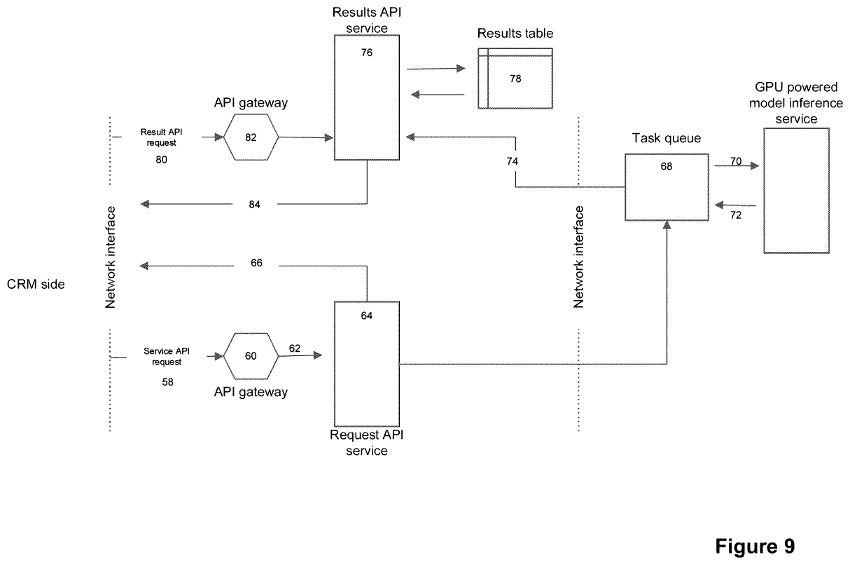

FIG. 9 is a block diagram illustrating in greater detail the structure of the API gateway service 14 and the Generative AI service 16. Their architecture and functionality will be described in greater detail below.

The API gateway service 14 is connected to the network interface of the CRM software application 12. The network interface is shown by a dashed line at the left of the drawing establishing a boundary between the CRM software application 12 domain and API gateway service 14 domain. A second network interface is defined between the API gateway service 14 domain and the Generative AI service 16 domain. The second network interface is also shown by a dashed line, and it defines a boundary between the API gateway service 14 domain and the Generative AI service 16 domain.

The sequence in which the API calls unfolds is also depicted at FIG. 9. At step 58, the CRM software application 12 initiates a service API call to an API gateway 60. This request transmits the JSON data previously generated, conveying the unstructured data and the data schema. This schema enables the Generative AI service 16 to organize the unstructured data in line with the schema. Subsequently, the API gateway 60 forwards this submission 62 to a request API service block 64. As a response to this submission, the service block 64 returns an acknowledgement 66 to the CRM software application 12, informing it that the service request is in progress. Additionally, the service block 64 routes the service call to a task queue 68. This task queue 68 retains all tasks destined for the Generative AI service 16. The Generative AI service 16 handles task requests supplied from a variety of API endpoints, with the depicted CRM software application 12 being just one example of endpoint. The Generative AI service 16 processes these tasks at 70 in the order they arrive unless there's a specific task priority in place. Task execution encompasses delivering the JSON data to the chosen LLM model as a prompt. In a specific example an LLM model that has been tested and that has been found to work well in the context of the present invention is GPT-4 that is made available by OpenAI, an AI research and deployment company. However, other LLM models can be used without departing from the spirit of this invention.

At step 72, the LLM model produces results. These outcomes comprise the pairing between keys and their corresponding values derived from the unstructured data. The structure of this key/value pairing can differ, but in one instance, the results are also presented as JSON data. The output data mirrors the data model (i.e., schema definition) that was provided in the prompt JSON data that was created initially. The LLM model essentially returns a JSON output with the values it extracted from the unstructured text based on the instructions provided. Additionally, the JSON output from the LLM is validated against the defined schema to ensure that the data returned meets the schema specifications. The results transit through the task queue 68 and they are passed at 74 to a results API service block 76. The results API service block 76 receives the results and stores the results in a results table 78.

The CRM software application 12 is set up so that fetching the structured data necessitates a distinct API call. In other words, the API gateway service 14 retains the results until the CRM software application 12 specifically requests them. This approach offers the entire system some load balancing benefits, as results are dispatched on-demand rather than being preemptively pushed to the CRM software application 12, which might coincide with times when the application is ill-equipped to accept them.

To be more precise, when the CRM software application 12 requires the results, it initiates a results API call 80 directed to an API gateway 82, which is different from the API gateway 60. As highlighted earlier, an architecture with distinct channels for managing service calls and results calls proves beneficial, as it offers a strategy for enhanced load balancing. In this fashion the flow of service calls and results calls through the first network interface with the client computing system and the flow of service calls and responses through the second network interface with the Generative AI service 16 do not require synchronization and can be asynchronous.

The API gateway 82 passes the results calls to the API service block 76 which searches the results table 78 for results and if results are available, they are sent to the CRM software application 12 at 84.

Referring back to FIG. 2, the GenAI service manager 24 processes the received results. This operation is also illustrated by the step 46 in FIG. 3. The GenAI service manager 24 processes the JSON data obtained from the Generative AI service 16, extracting the key/value combinations, which are then relayed to the CRM logic 20 for storage in the corresponding CRM record. This procedure entails mapping the keys to the information categories within the CRM record (which originally produced the keys) and subsequently saving the associated values under their respective information categories in the record.

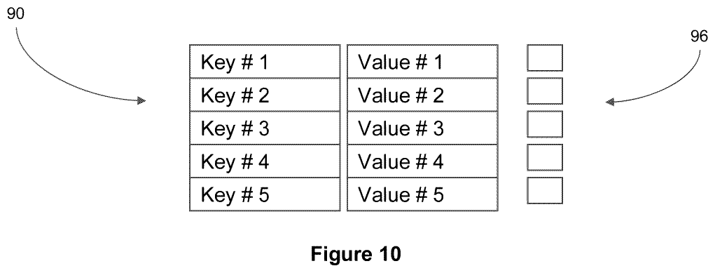

In a variant, illustrated at step 50 of FIG. 3, the extracted values are first presented to the user for validation before storage in the CRM record. FIG. 10 is a high-level depiction of a dynamic GUI control implemented on the user display by the GenAI service manager 24, based on the key/values combinations.

The GUI features a control 90 that displays the keys at 92 and their corresponding values at 94. This control also incorporates a selection tool 96, like a checkbox, to approve the key/value pairings. In this instance, each key/value pairing can be validated separately through individual selections. The act of entering the values into the CRM record is initiated based on the user's action and pertains solely to the key/value combinations that have been validated via their specific selection tool. The validation of the key/value pairings and the recordal of the validated key/value pairings by the user is illustrated by steps 52 and 54, respectively at FIG. 3.

It's worth noting that if an end user rejects a specific key/value pair through the Graphical User Interface (GUI), this feedback can be leveraged to enhance the training of the Language Learning Model (LLM) powering the Generative AI service 16 or trigger a new prompt with more specific guidance to avoid the incorrect response. If the LLM can be retrained, the incorrect response is used as training data during a re-training cycle of the LLM. If the LLM cannot be retrained, the rejected output can still be leveraged by indicating to the LLM that the response is incorrect and another response should be produced.

To implement the response re-generation option, a new prompt is produced—similar in most aspects to the original one—but with added instructions in one of the JSON objects, such as in the description field of the JSON object, to exclude the previously incorrect value for the specified key.

To elaborate, the GenAI service manager 24 receives the end user's feedback from the GUI. If any key/value pairs are rejected, the GenAI service manager 24 prompts the user with a dialog box, asking whether the Generative AI service 16 should regenerate its response.

If the user agrees, typically by clicking a button or another control interface on the GUI, the GenAI service manager 24 formulates a new prompt. This new prompt includes instructions to avoid generating the previously incorrect value. The prompt may be identical to the original prompt except for these additional instructions, or it may omit keys for which correct values were previously generated. In this case, the new prompt would convey the unstructured text along with the one or more keys associated with the incorrect values.

Following this, the process resumes as initially described: the revised prompt is sent to the Generative AI service 16, which then returns a new output featuring corrected values.

If the Language Learning Model (LLM) is capable of being retrained, the Generative AI service 16 can archive the prompt along with the key and incorrect response. This information can be used as training data and optionally combined with other sets of training data. Alternatively, the GenAI service manager 24 could store this information locally in a training data database. In this setup, a comprehensive training dataset is incrementally built and subsequently sent in batch form to the Generative AI service 16 for retraining the LLM. In this context, each time a user flags an incorrect value via the Graphical User Interface (GUI), the relevant information is added to the database, contributing to the assembly of the training dataset.

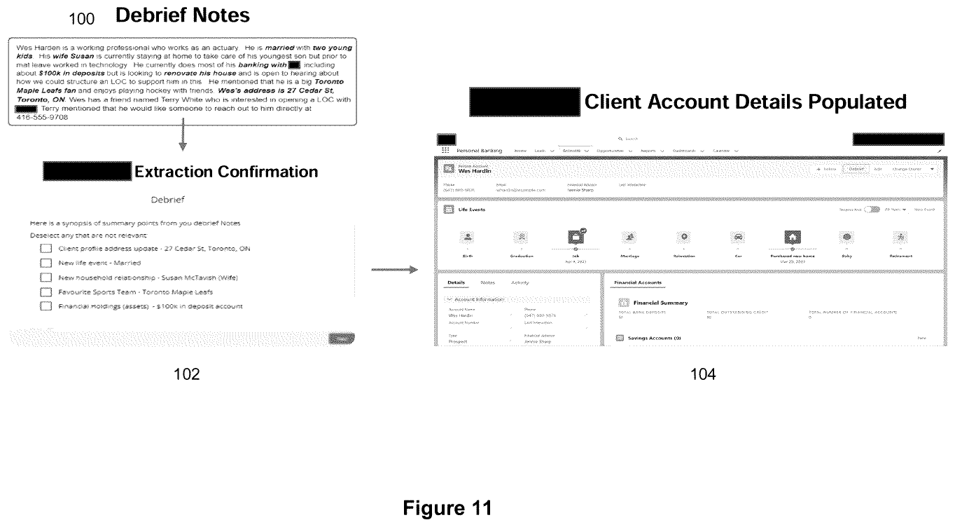

FIG. 11 provides a diagrammatic representation summarizing the conversion process, illustrating the sequence of steps as experienced by the end user at the client computing system. At step 100, the user produces advisory notes, either through typing them into the GUI text input interface or via voice dictation using speech recognition. In this illustration, the transformation of the advisory notes into structured format remains hidden from the user's view. Instead, the user is directly presented with a validation screen at 102, which displays the key/value pairs derived from their notes. The user has the discretion to deselect any irrelevant key/value pairs using checkboxes.

At 104 the selected values are placed in the corresponding fields of a CRM record. In this specific example, a CRM product from Salesforce in California is shown, however the invention is not limited to this particular CRM platform.

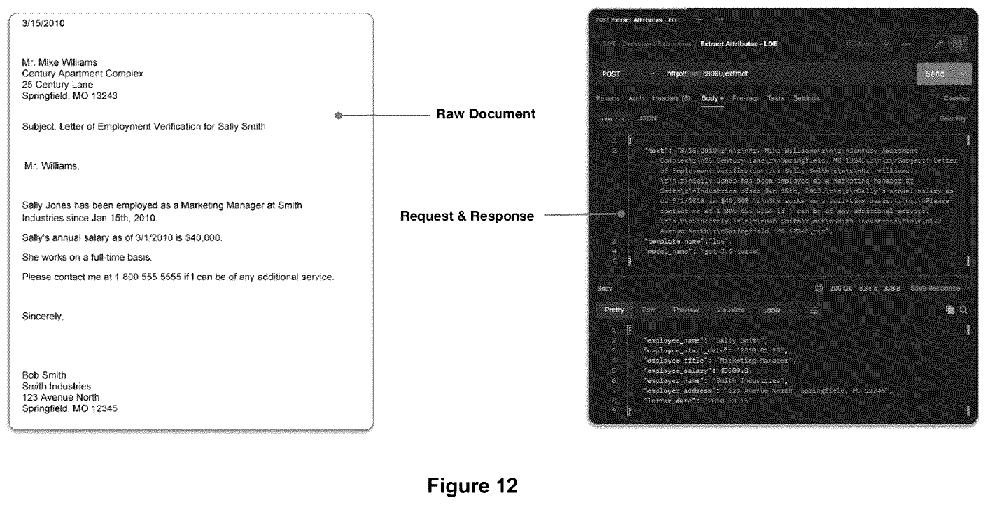

Although the invention has primarily been discussed above in the context of the financial sector, its applicability extends beyond this domain. FIG. 12 exemplifies a use case where a user record is populated based on an employment verification letter. In this scenario, the unstructured data, which is the content of an employment confirmation letter, is input in the CRM software application 12 by scanning the letter to generate text, or by other means.

The diagram also illustrates the code snippet showing both the request to the Generative AI service 16 and the subsequent response, which contains the filled-in values. The “text” JSON object encapsulates the unstructured content, followed by the keys and their corresponding extracted values. These keys encompass details such as the employee's name, start date, employee title, salary, as well as the employer's name, address, and the letter's date.

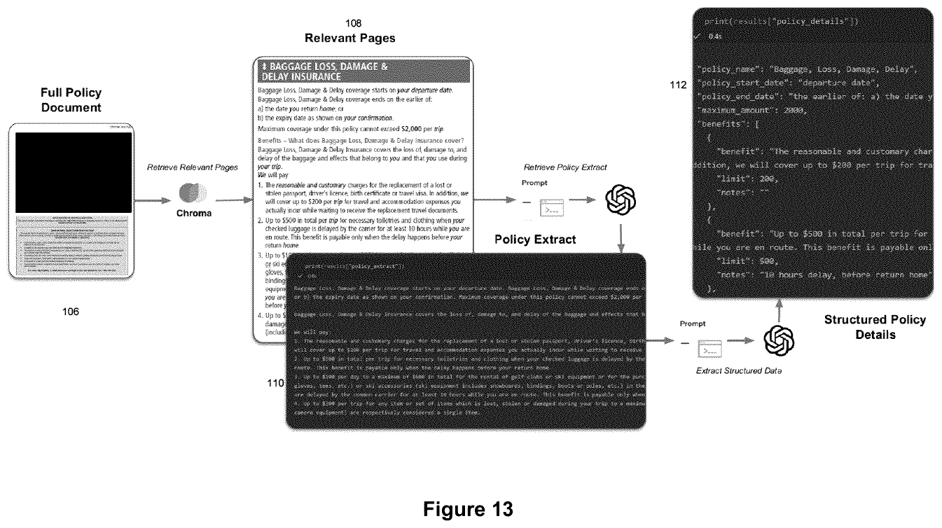

FIGS. 13 and 14 show another application of the optional aspect of the invention as it relates to data structuring, specifically in extracting details from insurance policies, such as coverage specifics. In FIG. 13, the process commences with step 106, where a comprehensive insurance policy document is processed to extract the most pertinent pages, denoted as 108. Note that these relevant pages 108 not only convey the unstructured text to be structured but also define a component of the data schema, namely the keys. The JSON data conveying the prompt, as visualized at 110, encapsulates the unstructured text, while the keys are depicted at 112. Transitioning to FIG. 14, the outcome of the Generative AI service is displayed, illustrating the output JSON data with the generated values from the AI operation, juxtaposed alongside their respective keys.

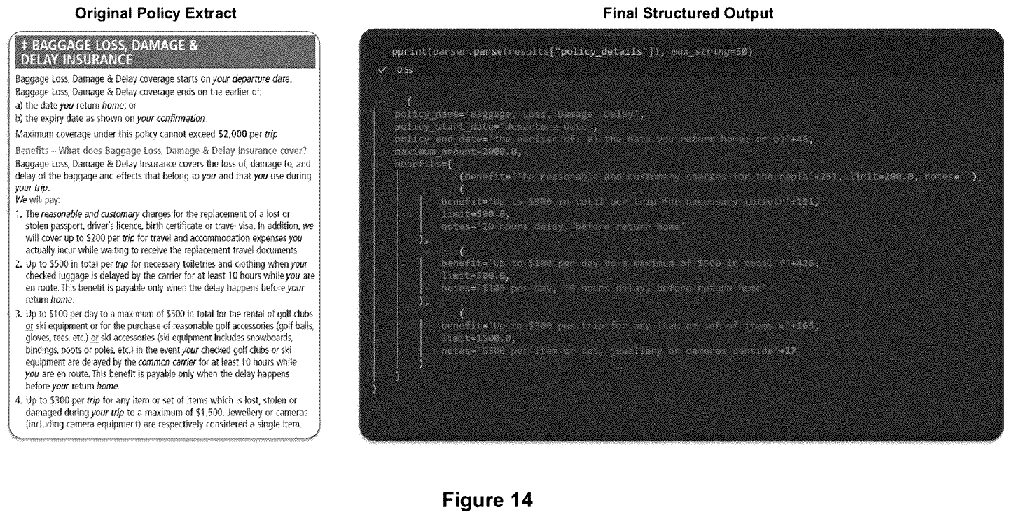

Referring back to FIG. 3, steps 55 and 57, which relate generally to workflow management will now be described. By way of context, reference will be made initially to FIG. 15, which illustrates the initial phase of the workflow as it relates to a commercial lending process.

FIG. 15 depicts a graphical user interface (GUI) showing the key lending term identification performed by the Generative AI service 16 within the debrief notes submitted by the service representative. In this instance, five lending-related points have been identified in the debrief notes, in connection with the loan, and each of these points can be independently selected by the service representative for exclusion from further consideration. Should any of these lending terms be deemed irrelevant for the processing, the service representative has the capability via the GUI controls to individually deselect them, typically accomplished by clicking the corresponding checkbox.

As previously explained, the extraction of values from the debrief notes is initiated by supplying the Generative AI 16 with keys. These keys can be drawn from the Customer Relationship Management (CRM) record, may be static keys, or can be directly input by the user. Subsequently, Generative AI Service 16 undertakes the task of analyzing the debrief notes and generating values that align with the provided keys.

It will be noted that the values output by the Generative AI system 16 are dependent on the keys initially input into the Generative AI system 16. When a service representative operates within a segment of the CRM software application 12 that pertains to general client information, the keys will primarily pertain to client identification details such as client names, addresses, phone numbers, and significant life events. In this instance, the Generative AI system 16 processing the debrief notes will output values that correspond to the client-information keys. However, the same debrief notes can also generate lending-related values, as long as lending-related keys are provided to the Generative AI system 16 information.

To facilitate the control of relevant key generation, the GenAI service manager 24 offers the capability to select a workflow from a predefined array of potential workflows. The chosen workflow subsequently dictates the specific key requirements. The workflow selection can be performed manually by the service representative, or it can be automated.

In the manual key generation approach, the GenAI service manager 24 presents the service representative with a workflow or more generally a context selection interface, enabling the service representative to delineate the context of the information required from the debrief notes. For instance, before the GenAI service manager 24 implements the GUI screen of FIG. 4 to the service representative, the GenAI service manager 24 provides a set of workflows or contexts to select from and that will be used as a basis to generate the relevant keys. The list of contexts can include general, client related information, and client specific workflows, such as lending workflow, money transfer workflow, etc. The service representative can select one or more workflows in the list and the GenAI service manager 24 logic will extract keys from the segments of the CRM record that correspond to the selected contexts. In this fashion, debrief notes that capture an initial conversation with a person that is not a client yet of the banking institution and who inquires about a loan, can populate the relevant segments of the CRM record, namely the general segment to input client identification information and thus open a file for the client, and a loan related segment to simultaneously trigger a loan workflow.

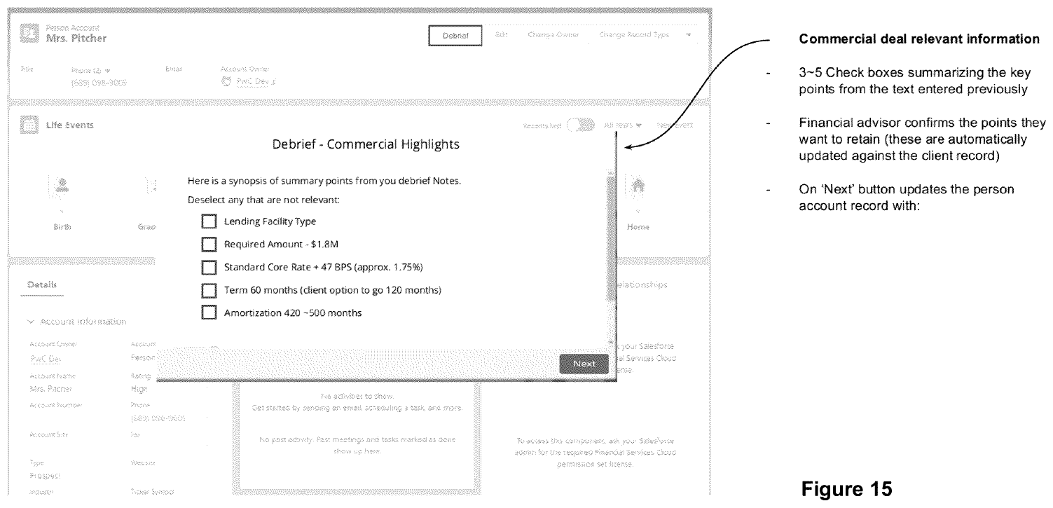

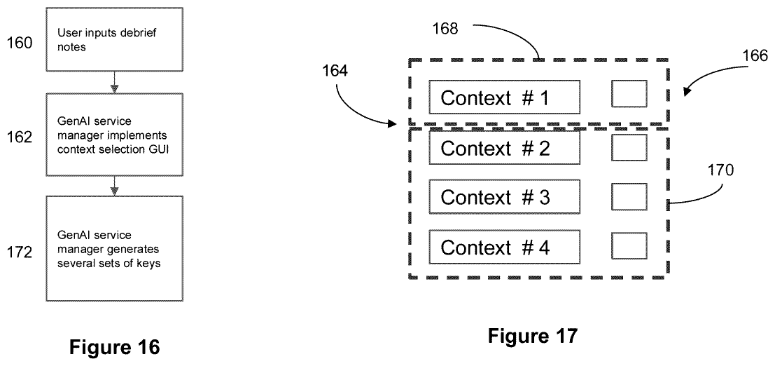

FIG. 16 is a flowchart that illustrates this process. At step 160, the user inputs the debrief notes at the GUI of the CRM record. Before generating keys, the user is prompted to select the relevant context for the keys generation. At step 162, the GenAI service manager 24 implements a context selection interface that provides the user with context selection options. An example of such context selection interface is the GUI shown at FIG. 17. The GUI lists on the left side a series of contexts 164 and on the left the GUI presents a selection control 166, which has a plurality of individually selectable options associated with respective contexts. The selectable options are checkboxes, but other kinds of selection mechanisms are possible. Optionally, the contexts are grouped into themes. For example, one such theme 168 is a general theme, relating to client identification information, such as name, address, telephone number, etc. Another possible theme is a workflow related theme 170, relating to workflows which are associated with products and services that the banking institution could deliver to a client.

Referring back at FIG. 16, at step 164 the GenAI service manager 24 gets the user selections from the context selection GUI and identifies from the user selections the relevant segments of the CRM record where the keys will be sourced. Assume that the user has selected context #1 which relates to general client information and context #3, which relates to a specific workflow such as a commercial lending workflow. The GenAI service manager 24 functionally links to the corresponding segments of the CRM record, namely the general segment and the commercial lending workflow segment and generates two corresponding sets of keys, as shown at step 172. The process then proceeds as it was described earlier, namely the keys are used to generate JSON data key/value combinations which are submitted to the Generative AI service 16 for processing to identify from the debrief notes the corresponding values.

To sum up this example, the output of the Generative AI service 16, includes values which are associated with a workflow, such as a lending workflow. The values are then presented to the user via the GUI at FIG. 15 for validation and ultimately recording in the CRM record.

As an alternative approach, it is feasible to automate the procedure by instructing the Generative AI service 16 to autonomously initiate the workflow selection process based on the content of the debrief notes, rather than requiring explicit input from the user to make a workflow selection. This can be done by providing in the prompt that is sent to the Generative AI system 16 a list of the possible workflows as categories and requesting the Generative AI service 16 to classify the debrief notes in one of the categories. Specifically, the “description” field of the data schema is provided with a list of the possible workflows along with a statement asking the Generative AI system 16 to:
1. Classify the debrief notes in the relevant workflow category or return “null” if no relevant category is found;
2. Extract the key financial terms.

An example of a code snippet is as follows:
“title”: “Workflow and key financial terms” “description”:
“Identify the relevant workflow category among the group consisting of commercial lending, personal lending, money transfer, securities purchase, and extract the key financial terms associated with the selected category”.
“type”: [“string”, “null”]

In this example, the Generative AI system 16 is requested to select among four exemplary workflows, it being understood that in practice there will be many more workflows listed, such as several dozens and even hundredths workflow options. Also, the Generative AI system 16 is asked to extract key financial terms. An example of this output is shown at FIG. 16, where the workflow is identified as “Lending Facility” and the key financial terms are listed below, in particular “Required Amount”, “Standard Core Rate”, “Term” and “Amortization”.

The selection of workflows within the “description” field, utilized in conjunction with debriefing notes, is derived dynamically from the CRM record. As previously outlined, the CRM record is organized into distinct segments, with each one correlating with a specific workflow.

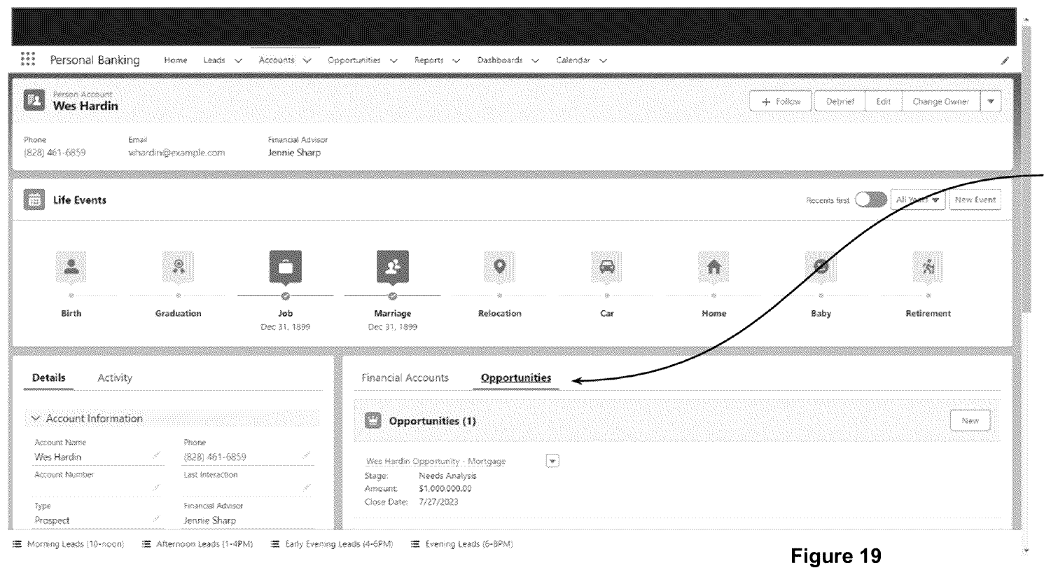

In practice, when a service representative is required to execute a particular workflow, they will activate the corresponding segment within the CRM record that defines the necessary procedural steps under the selected workflow. In the context of dynamic key generation, the GenAI service manager 24 systematically retrieves a list of potential workflows encoded within the CRM record and populates this list within the prompt. Accordingly, the workflow selection process is aligned with the workflow inventory in the CRM record, such that only workflows which are supported by the CRM record can be offered for selection to the Generative AI service 16. Assuming the output of Generative AI system 16 is deemed correct by the user and accepted, such as by clicking on the “Next” button, the GenAI service manager 24 will interface with the CRM record and store the values in the record. In particular, the GenAI service manager will place the values in association with the respective keys in the segment of the CRM record that is associated with the workflow. A screenshot of the CRM record is shown at FIG. 19. In the disclosed embodiment, the record is structured to incorporate multiple categories of information. In the upper section of the record interface, persistent client-specific details are displayed, comprising the client's name, telephone number, and electronic mail address, which are generally static over time. Additionally, the record integrates a chronological diagram that maps significant life events of the individual, serving as temporal milestones that may hold relevance in the provision of professional services to the said individual. In a designated area, typically located on the lower right quadrant of the interface, an “Opportunities” tab is situated. Activation of this tab grants access to client-specific workflows. Detailed information regarding each workflow can be retrieved under the same “Opportunities” tab.

By way of illustration, the interface exhibits a single opportunity linked to a mortgage. Interaction with the mortgage link triggers the corresponding workflow embedded within the CRM record.

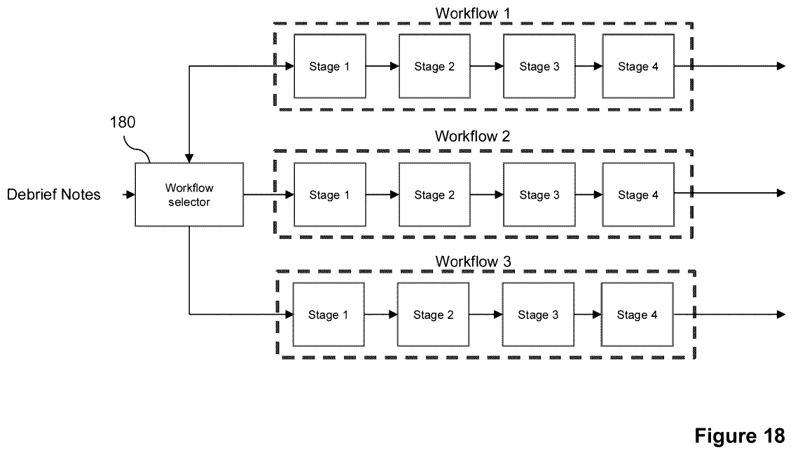

This activation delineates the sequential steps integral to the delivery of a mortgage product to the client. FIG. 18 is a conceptual representation of the logic of the GenAI service manager 24 as it relates to automated workflow selection and management. From a functional perspective, the GenAI service manager 24 implements a workflow selector and manager 180 block which processes the debrief notes via the Generative AI service 16, as described earlier, to select a workflow among a set of workflows. Alternatively, the workflow selector and manager 180 can respond to manual user input at the GUI, where the user manually selects a workflow among the set of workflows. In the manual selection approach, there is no interaction with the Generative AI service 16, at least for the workflow selection of the overall process.

The workflow selector and manager 180 also performs the activation of the selected workflow. As illustrated in FIG. 18, there are three potential workflows presented, with the understanding that the invention allows for the inclusion or reduction of additional workflows without departing from its fundamental concept. Each of these workflows is characterized by a series of distinct stages or steps. In a typical scenario, a stage represents a specific and concrete milestone within the workflow where a particular outcome or achievement is attained.

The GenAI service manager 24 typically performs multiple interactions with the Generative AI service 16 throughout the execution of the selected workflow. To illustrate, there may be one or several calls initiated by the GenAI service manager 24 with the Generative AI service 16 within a single stage of the workflow. Each interaction with the Generative AI service 16 generates an outcome, typically in the form of data, which is then presented to the user and/or stored in the CRM record. This data contributes to the advancement of the current stage and, consequently, the overall workflow execution. The produced data in turn triggers the initiation of the subsequent step within the workflow, which may necessitate a subsequent call with the Generative AI service 16. This iterative process continues until the workflow is successfully concluded.

The successive interactions with Generative AI Service 16 are functionally linked to each other by developing, for each interaction, a prompt for instructing the AI service, predicated on outcomes procured from a preceding interaction. By modulating the prompt in alignment with preceding outputs, the process enacted by the Generative AI Service 16 is guided to converge towards workflow completion, ensuring a coherent progression through the operational workflow sequence.

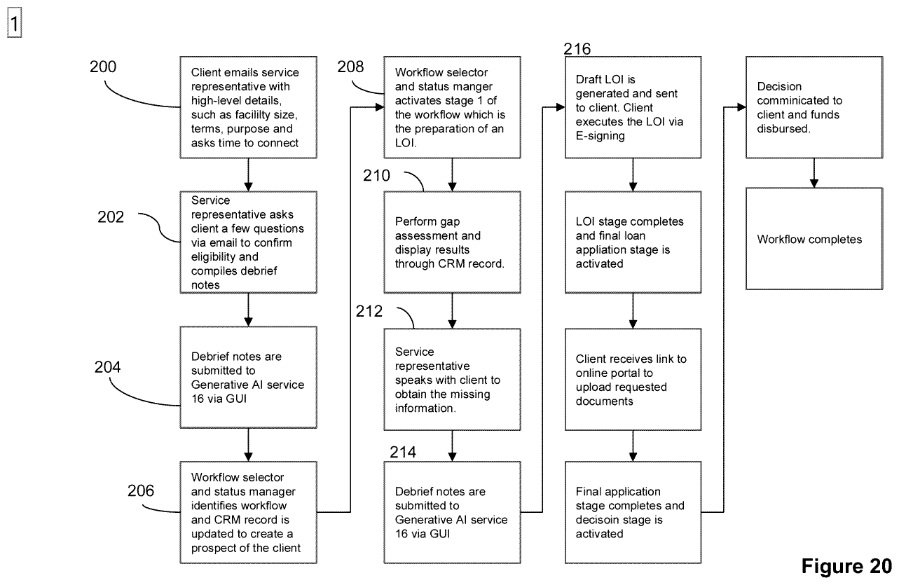

The iterative process is illustrated with more granularity by the flowchart of FIG. 20, in the context of a specific client interaction in the context of a commercial lending project. At step 200 a client emails a service representative of the banking institution to request a proposal in connection with a commercial lending. The client email will typically convey some high-level details of the project, such as the facility size, terms, and purpose.

At step 202, the service representative receives the client's email and, based on the initial information provided, may respond with additional inquiries to ascertain the client's eligibility for further project consideration. Assuming the client promptly responds with the necessary information, the service representative now possesses sufficient data to start the automated process through the CRM platform 12. More precisely, at step 204, the service representative formulates a set of debrief notes, outlining the ongoing communication with the client. These debrief notes can be created in various ways, such as copying and pasting the email correspondence with the client, composing them as unstructured text, or even using speech-to-text conversion by verbally articulating the notes.

At step 204, the debrief notes are entered via the GUI interface and processed by the GenAI service manager 24, as described earlier. This processing involves the generation of a prompt to guide the processing of the debrief notes by the Generative AI service 16. In this example, the prompt is configured to perform two specific tasks, namely extract identification information for the client to allow the banking institution to open a client specific record in the CRM software application 12 and also identify a workflow among a set of workflows. The extraction of the identification information includes identifying in the debrief notes the client name, company name, telephone number, among others. This is performed by extracting or otherwise generating keys which are integrated in the prompt, where each key will receive a value identified by the Generative AI service 16 within the debrief notes.

As discussed earlier, the workflow identification is performed similarly. The prompt includes a “workflow” key and the Generative AI system 16 is requested to return a value for that key, where the value is a selection of an item in a workflows list included in the prompt which aligns best semantically with the debrief notes.

The GenAI service manager 24 submits the prompt, which includes the instructions for the two tasks and the content of the debrief notes to the Generative AI service 16. The request is processed by the Generative AI service 16 as previously described and the Generative AI service 16 returns the results which include the client identification values and a workflow value.

The data received from the Generative AI service 16 is optionally validated by the service representative, by displaying the values via a GUI, such as the one shown at FIG. 15, where the service representative can individually validate the various elements of information.

Once the validation is performed by the service representative, the CRM record is updated, as shown at step 206 by the GenAI service manager 24, which in this embodiment of the invention includes an augmented functionality relating to workflow management Conceptually, this augmented functionality is implemented by the workflow selector and manager 180. When the selected workflow value is returned by the Generative AI service 16, the workflow selector and manager 180, activates within the CRM record the selected workflow, such that the workflow execution can begin.

The CRM record has a segmented architecture where different segments are associated with respective workflows. Each segmented portion of the CRM record not only delineates the structure and sequence of the associated workflow but also serves as a centralized repository for information pertinent to the execution of the different workflow phases or steps, such as keys, or other data necessary for the workflow execution. This segmentation facilitates an organized approach to managing client engagements, ensuring that each step of the workflow is executed in a predictable and controlled fashion and is also traceable within the CRM record. system. For instance, let's consider the CRM record's workflow segment associated with commercial lending. This commercial lending segment delineates the different stages of the workflow and their sequential order. It starts with the initial stage and proceeds through each subsequent stage until it reaches the final stage, marking the completion of the entire workflow.

Moreover, in addition to outlining the stages and their sequence, the segment defines the specific criteria that must be satisfied to consider a stage of the workflow as completed. These criteria may involve the submission of specific pieces of information, certification by the service representative or their team to confirm the completion of a validation or decision-making step, or the execution of necessary documents by either the client or the service representative.

The segment may optionally incorporate standardized document templates which are necessary for the execution of a specific workflows. The workflow selector and manager 180 can integrate the template within a prompt and request the Generative AI Service Manager 16 to perform a customization of the template for bespoke tailoring to address the unique requirements of each case.

Each document template is constructed as an aggregate of various legal provisions, with each provision consisting of one or more paragraphs. Within these templates, certain provisions are mandatory and must remain intact, reflecting mandatory legal or regulatory stipulations. Conversely, there exist provisions that are discretionary, allowing for customization based on the individual circumstances of the client engagement. These optional provisions afford the flexibility to either include or exclude them contingent upon their relevance to the client's specific context.

To ensure comprehensive coverage across a broad spectrum of potential client scenarios, the document templates are initially designed with an inclusive approach, incorporating all conceivable optional or elective provisions. Subsequently, a selection process is undertaken to excise any provisions that do not pertain to the bespoke requirements of a particular client project, thereby achieving a tailored document that aligns with the client's distinctive needs. At step 208, the workflow selector and the manager 180 activates the first stage of the selected workflow which corresponds to a commercial lending project. The typical first stage of such project is the completion of a Letter of Intent (LOI,) which involves the generation of an LOI document, which is tailored to the client's project, some negotiation of the LOI document and when both the client and the banking institution agree on the LOI, the execution of the LOI by both parties.

As discussed above, the LOI includes several provisions that establish the framework for the lending agreement. For the efficient and timely creation of the LOI draft, it is necessary to adequately address all requisite provisions. This entails the acquisition or identification of information items pertinent to each provision.

The data elements, relevant to the generation of the LOI draft, are cataloged within the CRM record and serve as key inputs that can be introduced in a prompt to the Generative AI service 16. This facilitates the extraction of corresponding values from debrief notes or any supplementary client documentation also presented to said service. Consequently, this methodology largely automates the process of acquiring information for inclusion in the LOI draft, significantly mitigating the dependency on manual document analysis for information extraction.

At the conclusion of step 208 the GenAI service manager 24 and its workflow selector and manager 180 have been provided by the Generative AI service 16 with a workflow selection and also with values associated with keys which correspond to LOI provisions, such as interest rate, value of the loan, amortization period of the load, etc. The extraction of this information from the debrief notes may be done in a single interaction with the Generative AI service 16 or as a series of sequential interactions. For example, there may be a first interaction with the Generative AI service 16 to select the workflow. After the workflow has been selected the GenAI service manager 24 will extract keys from the CRM record segment corresponding to the selected workflow and prompt the Generative AI service 16 again to extract values corresponding to the supplied keys.

At step 210, the workflow selector and manager 180 initiates a gap analysis process aimed at identifying the remaining data elements required to finalize the Letter of Intent (LOI) draft. Specifically, the Workflow selector and manager 180 conducts a comparison between the keys associated with information derived from debrief notes and the comprehensive set of keys necessary to create a complete LOI draft.

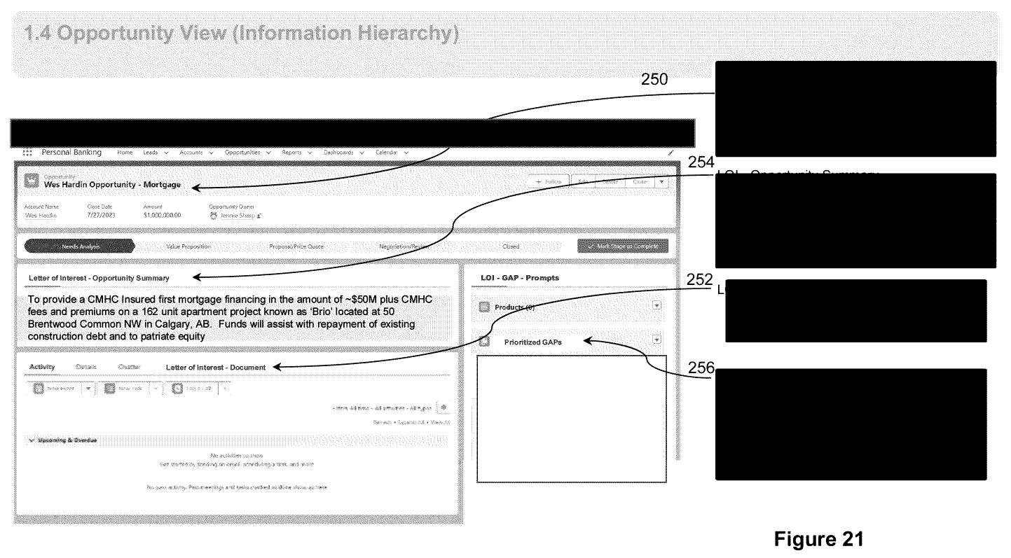

The results of this gap analysis are communicated to the service representative through the GUI managed by the GenAI service manager 24. This GUI, illustrated in FIG. 21, includes several components:

Element 250 indicates the selected workflow. Element 252 serves as a control element outlining the various stages of the workflow, with a particular focus on highlighting the current (active) stage, which is the LOI stage. Element 254 displays the debrief notes. Element 256 is used to list the information gaps.

In this context, “gaps” refer to the missing pieces of information necessary for generating a complete LOI. The GenAI service manager 24 compares the necessary keys, previously extracted from the relevant segment of the CRM record, with the keys that already have associated values. Any keys lacking associated values are presented via the control element 218.

This process of identifying and displaying the missing keys required to complete the LOI serves to direct the service representative's attention toward achieving this immediate goal. For example, the service representative may choose to contact the client via phone or email, providing them with a list of the missing information items necessary to expedite the completion of the LOI stage.

Referring back to the flowchart of FIG. 19, at step 212, the service representative speaks or emails the client to ask the information in relation to the missing information items. At step 214 a new set of debrief notes is produced by the service representative and input in the CRM software application 12 based on the discussions with the client. The GenAI service manager 24 makes another call to the Generative AI service 16, inputting the new set of debrief notes in the prompt along with the missing keys, where the prompt requests the Generative AI service 16 to identify values for the missing keys in the debrief notes.

Assuming that the Generative AI service 16 returns all the missing values for the generation of the draft LOI, the process continues at step 216 where a customized LOI draft is produced. As indicated above, the segment of the CRM record stores an LOI template which is a collection of provisions, where each provision is represented by text, such as single paragraph or multiple paragraphs. Each provision embedded within the document template is associated with a corresponding set of metadata. The metadata is purposed to augment the utility of the document template by providing descriptive, explanatory, and locational information, which serves to facilitate the efficient retrieval, application, and administration of the said provision's content. In particular, the metadata operates in distinguishing between mandatory and elective or optional provisions within the LOI, optionally providing a concise summation thereof, which serves to clarify the relevance of each provision under a spectrum of different situations. The GenAI service manger 24 makes a call to the Generative AI service 16 to make an initial selection of the elective provisions in the document template that best match the circumstances of the client engagement. The GenAI service manager 24 assembles a prompt which includes the elective provisions of the document template and also engagement-specific information which represents the specifics of the client situation. Mandatory (required) provisions of the document template may not be included in the prompt because those provisions are not elective, and they must be present in the LOI document. The GenAI service manager 24 distinguishes between the elective provisions and the mandatory ones based on the metadata associated with each provision which indicates whether the block of text associated with the provision is elective or mandatory.

The aggregation of keys that have been previously assigned non-null values forms a dataset of engagement-specific information, encapsulating aspects of the client's unique situation. This curated information can be used for the selection of elective provisions. Not all keys are relevant for this operation. Keys that relate to client identity information, such as client name, telephone number, etc. are likely not relevant for the selection of elective provisions. The relevant keys are those that relate to specifics of the particular business process that the workflow tries to perform. In the context of commercial lending, the keys associated with parameters such as purpose of the loan, loan amount, interest rate, collateral, repayment schedule, documentation required, fees, etc. constitute parameters that dictate the composition of the LOI and accordingly, the elective process of the provisions in the LOI template.

In a specific example of implementation, the text block(s) of each elective provision is placed in an object of the data interchange format entity, which can be JSON or other. The list of all the keys that have non-nil values associated to them are provided as well in the object along with the request to semantically match the text of the provision to anyone of the listed keys. The Generative AI service 16 returns the keys in the provided list that have some semantic similarity with the text of the provision. If there is no semantic similarity, between anyone of the keys and the text of the provision, the Generative AI service 16 returns “nil”.

Accordingly, the output generated by the Generative AI service 16, as returned to the GenAI service manager 24, conveys the elective provisions each associated with the keys that hold semantic significance relative to the content of those provisions. Elective provisions paired with “nil” values indicate potentially extraneous provisions, insofar as they pertain to specific conditions of the case in question, and thus should be removed from the draft version of the LOI. Optionally, the service representative is provided with an identification of the elective provisions that are being removed from the template document allowing the service representative to validate those selections. This operation is performed via a GUI, similar to the one shown in FIG. 15. For instance, the GUI identifies the elective provisions that have been removed (alternatively identifies the elective provisions that are retained) and provides controls allowing the service representative to individually validate the selection process. Once the validation is completed, the customized draft LOI is stored in the CRM record and is part of the file documentation which can be further edited if necessary or it can be directly sent to the client or to other internal team members for review.

In an alternative embodiment, the invention is configured to furnish the Generative AI system 16 with a comprehensive dataset comprising the entirety of knowledge accrued throughout the workflow process, inclusive of debrief notes and key/value associations, rather than a limited dataset consisting solely of keys possessing non-nil values. This richer data input provides the Language Model with enhanced contextual awareness, thereby improving its capability to select the elective paragraphs pertinent to the subject matter while disregarding those deemed irrelevant.

A method for implementing the alternative embodiment includes providing a prompt structure which comprises integrating a data set containing debrief notes and key/value combinations into the prompt, alongside elective paragraphs. For each elective paragraph, the Generative AI service 16 is solicited to determine its relevance to the dataset and, optionally, to provide a summary of commonalities between the dataset and the elective provision. The output generated by the Generative AI service 16 includes responses for each elective provision. In the case of lack or relevance between a provision and the dataset, the response indicates such. In instances of relevance, the summary identifies the shared attributes, thereby facilitating the service representative's decision-making process regarding the inclusion or exclusion of elective provisions.

In this particular embodiment, the output of the Generative AI system 16 is presented to the service representative through the GUI. The GUI displays the Generative AI system 16's evaluation of the relevance of each elective provision to the dataset, including the summarized relevance information. Additionally, the GUI offers selection controls to aid the service representative in identifying the elective paragraphs to be incorporated into the LOI draft with ease. The control can be a check box where the service representative can selectively place a checkmark to indicate that the elective paragraph is selected or conversely deselected. The GenAI service manager 24 uses the input by the service representative on the GUI to store a version of the template, with some of the elective provisions removed, as a draft LOI.

In a yet another possible variant, the GenAI service manager 24 generates the prompt with a request to rewrite or edit the text of the elective provisions to take into account previously generated information, in particular values that have been previously obtained and associated with keys. In this fashion, the LOI draft is generated at a more advanced stage of completion and does not require (or requires less) editing provision templates to include client specific information and/or project specific information. In this example, the prompt structure includes keys and associated values, alongside the LOI initial draft, where the process of selecting the elective provisions has already been completed. Accordingly, the automated editing of the LOI draft would typically be performed at a subsequent step after the selection of the elective paragraphs has been carried out.

Referring back to the flowchart of FIG. 20, after execution of step 216, the workflow proceeds with the remaining steps including activation of the final loan stage application, setting up an online portal for the client to upload requested documents, final decision stage and if loan approved, disbursement of funds.

In another variant of the invention, the system provides a real-time assistant functionality, specifically designed to facilitate support for a user, such as a service representative, during an active dialogue with a client. Contrasting with the previously discussed embodiment, the real-time functionality necessitates that the output from the Generative AI service 16 possesses minimal latency, ensuring quick response capabilities aligned with the pace of the ongoing live dialogue. The real-time assistant functionality finds numerous practical applications in many industries, in particular service cases where the interaction between the service representative and the client is limited in time and would not require the generation and revision of complex legal documents.

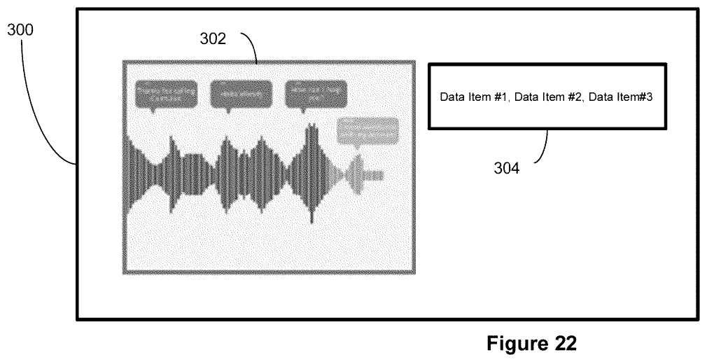

Referring to FIG. 22, an illustration of the GUI for CRM software application 12 is presented, showing the integration of the real-time assistant functionality. In the given use-case, consider a banking institution client initiating a call to the service representative to execute an international wire transfer. Conventionally, such a transaction is straightforward, typically not necessitating repeated client interactions. Within a singular interaction, the service representative should be able to obtain all requisite information from the client to execute the transfer. The real-time assistant functionality serves to guide the service representative in posing pertinent inquiries to the client. This ensures the comprehensive collection of the required data for the wire transfer.

The GUI 300 includes a number of panels in which information is presented. One such panel 302 shows the conversion of audio captured during the conversation between the client and the service representative into text. In the example shown, the audio waveform appears and alongside the waveform the conversion in text. The text derived from the audio is the equivalent of debrief notes. Those are processed by the GenAI service manager 24, which integrated them in a prompt and makes a call to the Generative AI service 16 with a request to match the converted text to a workflow. In order to accurately perform the workflow identification, it is preferrable to accumulate a certain amount of text which conveys enough context to make a workflow selection.

Referring to a situation where the client and the service representative have engaged in a dialogue for an extended period, the audio and corresponding textual data are aggregated. Upon reaching a predefined threshold, a request is sent to the Generative AI service 16. In response, the Generative AI service 16 conducts workflow determination and selects an appropriate workflow from a predefined set of potential workflows.

This chosen workflow is then displayed in a designated interface, pane 304, managed by the GenAI service manager 24, concurrent with the ongoing dialogue between the service representative and the client. Pane 304 is equipped with interactive controls, enabling the service representative to input actions, including but not limited to, validation of the decisions and, more broadly, the outputs provided by the Generative AI service 16. As an instance, pane 304 might display “International wire transfer” as the elected workflow. Incorporated controls, such as an “OK” button, permit the service representative to confirm the correctness of the workflow selection. Conversely, a “CANCEL” button allows for the indication of an incorrect workflow selection.

In response to the input by the service representative confirming the correctness of the workflow selection, the GenAI service manager 24 will identify and activate the corresponding segment of the CRM records, which in this example corresponds to an international wire transfer. Once this segment of the CRM record is identified, the GenAI service manager 24 will perform key extraction, as previously described, to obtain the necessary keys to perform an international wire transfer. The keys and the textual data currently accumulated during the call are packaged in a prompt and sent to the Generative AI service 16 during a second call, where the Generative AI service 16 attributes values to the keys, to the extent those values exist in the textual data.

As a subsequent step, the GenAI service manager 24 performs a gap assessment, which includes a comparison between the keys for which values have been identified in the existing text and keys with missing values. The keys with missing values are identified in the pane 304 such as to allow the service representative to ask the client for the missing information while the call is ongoing. Examples of keys relating to an international wire transfer include the account number to debit, the account number to credit, amount of money to transfer and account number to debit for the transaction fees, among others. During the call, the client may have specified all the information except indicate which account to debit for the transaction fees. This gap is identified in the pane 304 and the service representative can ask the client for the missing information, such that the wire transfer process can be completed without the need to re-contact the client.

In various embodiments, the methodologies discussed herein are executed by one or more specialized computing devices. These devices might be designed specifically to execute these methods or might encompass digital electronic components like application-specific integrated circuits (ASICs) or field programmable gate arrays (FPGAs) that are consistently programmed to perform the methods. Alternatively, they may consist of general-purpose hardware processors such as CPUs and/or GPUs instructed to perform the techniques according to firmware, memory, other storage solutions, or a mix of these.

The storage solutions can be a random-access memory (RAM) or another type of dynamic or static storage device. This device is responsible for long term storage or short-term storage of data and instructions meant for the processors. The device can also hold temporary data or intermediary details when the processor is executing instructions. When these instructions are retained in storage devices that the processor can access, they transform the computer system into a specialized machine tailored to carry out the operations described in those instructions.

1. A non-transitory computer-readable storage medium storing instructions, that when executed by one or more computers configures the one or more computers to perform the steps of:
a. receive at an input of the one or more computers, unstructured data;
b. output at an interface of the one or more computers, a request to a Generative AI system to associate the unstructured data to a workflow selected among a set of workflows, wherein each workflow in the set of workflows is characterized by a series of steps;
c. receive from the interface as a result of processing by the Generative AI system an identification of the selected workflow.

2. A non-transitory computer-readable storage medium as defined in claim 1, wherein the input is implemented by a GUI.

3. A non-transitory computer-readable storage medium as defined in claim 2, wherein the GUI includes a control element.

4. A non-transitory computer-readable storage medium as defined in claim 3, wherein the unstructured data includes text, the control element being configured to capture a text input from a user.

5. A non-transitory computer-readable storage medium as defined in claim 1, wherein the request conveys the unstructured data, which includes text.

6. A non-transitory computer-readable storage medium as defined in claim 1, wherein the request conveys the set of workflows from which the Generative AI system is to select the workflow in the set associated with the unstructured data.

7. A non-transitory computer-readable storage medium as defined in claim 1, wherein the unstructured data is derived from audio.

8. A non-transitory computer-readable storage medium as defined in claim 1, including the step of activating in a CRM record, which includes a plurality of segments associated with one or more of the workflows in the set of workflows, a segment corresponding to the selected workflow.

9. A non-transitory computer-readable storage medium as defined in claim 8, including:
a. implementing at the one or more computers a Graphical User Interface (GUI) displaying to a user the workflow selected by the Generative AI system, wherein the GUI includes a validation control allowing the user to validate the selected workflow;
b. in response to user input at the validation control indicating that selected workflow is valid, activating the segment CRM application corresponding to the selected workflow.

10. A non-transitory computer-readable storage medium as defined in claim 8, including the step of extracting the set of workflows from the CRM record.

11. A method executed by one or more computers comprising the steps of:
a. receive at an input of the one or more computers, unstructured data;
b. output at an interface of the one or more computers, a request to a Generative AI system to associate the unstructured data to a workflow selected among a set of workflows, wherein each workflow in the set of workflows is characterized by a series of steps;
c. receive from the interface as a result of processing by the Generative AI system an identification of the selected workflow.

12. A method as defined in claim 11, wherein the input is implemented by a GUI.

13. A method as defined in claim 12, wherein the GUI includes a control element.

14. A method as defined in claim 13, wherein the unstructured data includes text, the control element being configured to capture a text input from a user.

15. A method as defined in claim 11, wherein the request conveys the unstructured data, which includes text.

16. A method as defined in claim 11, wherein the request conveys the set of workflows from which the Generative AI system is to select the workflow in the set associated with the unstructured data.

17. A method as defined in claim 11, wherein the unstructured data is derived from audio.

18. A method as defined in claim 11, including the step of activating in a CRM record, which includes a plurality of segments associated with one or more of the workflows in the set of workflows, a segment corresponding to the selected workflow.

19. A method as defined in claim 18, including:
a. implementing at the one or more computers a Graphical User Interface (GUI) displaying to a user the workflow selected by the Generative AI system, wherein the GUI includes a validation control allowing the user to validate the selected workflow;
b. in response to user input at the validation control indicating that selected workflow is valid, activating the segment of CRM application corresponding to the selected workflow.

20. A method as defined in claim 18, including the step of extracting the set of workflows from the CRM record.
